(19) United States
(12) Patent Application Publication
(10) Pub. No.: US 2022/0329624 A1
(43) Pub. Date: Oct. 13, 2022

(54) SYSTEM TO DETECT AUTOMATED WEB SUBMISSIONS

(71) Applicant: Citrix Systems, Inc., Ft. Lauderdale, FL (US)

(72) Inventors: Rama Rao Katta, Fremont, CA (US); Kasirao Velugu, Bengaluru (IN); Aman Agrawal, Bangalore (IN)

(73) Assignee: Citrix Systems, Inc., Ft. Lauderdale, FL (US)

(21) Appl. No.: 17/226,337

(22) Filed: Apr. 9, 2021

(51) Int. Cl. H04L 29/06

(52) U.S. Cl. CPC H04L 63/1483; H04L 63/0236

(57) ABSTRACT

A system to identify automated submissions of web pages, such as those submitted by bots, in real time. The system comprising a processor configured to update an initial version of a requested web page with at least one hidden field, transmit the updated web page to the client, then, upon receipt parse the completed web page, and identify if a data entry is associated with the at least one hidden field. Where a data entry is associated with the at least one hidden field, the system blocks the transmission of the completed web page to the server. Where a data entry is not associated with the at least one hidden field the system removes the at least one hidden field, and transmits the final web page to the server.

### BACKGROUND

A bot is a software application that runs automated tasks over the internet. One of the most common uses for bots is to crawl web pages for content and webforms. Over 40% of all internet traffic is generated by bots. Sometimes the bots are used to gather information in a helpful manner that is significantly more efficient than a human researcher. But many times, bots are used to create fake accounts, spam data, and consume resources on web servers. Bots access web pages, analyze them for information fields, fill them with randomly generated data, and submit the completed pages back to the web servers.

### SUMMARY

In at least one example, a computer system is provided. The computer system includes a network interface, a memory, and at least one processor coupled to the memory and the network interface. The at least one processor is configured to receive, from a client via the network interface, a request to obtain a web page and then transmit the request to a server. The processor is also configured to receive, from the server, an initial version of the web page and to embed at least one hidden field in the initial version of the web page to create an updated version of the web page. The processor is further configured to, transmit, to the client, the updated web page. Upon completion by the client, the processor is configured to receiving, from the client, a completed version of the web page, and determine whether the at least one hidden field is populated within the completed version of the web page. Then, where the at least one hidden field is not populated, the processor is configured to remove the at least one hidden field form the completed version of the web page to create a final version of the web page, and send the final version of the web page to the server.

Examples of the computer system can include one or more of the following features.

In the computer system, the at least one processor may be further configured to generate a session identifier, generate at least one identifier of the at least one hidden field, and store, in the memory, the session identifier in association with the at least one identifier of the at least one hidden field.

In the computer system, the one or more processors can be further configured to transmit, to the client, the session identifier, and receive, from the client, the session identifier in association with the completed version of the web page.

The computer system may further include a distributed hash table, where the at least one processor is further configured to store, in the distributed hash table, the session identifier in association with the at least one identifier of the at least one hidden field. The processor is further configured to retrieve, from the distributed hash table, using the session identifier, the at least one identifier of the at least one hidden field.

In the computer system, where the at least one hidden field within the completed version of the web page is populated, the processor is further configured to block the client.

In the computer system, the initial version of the web page includes a visual layout, where to embed the at least one hidden field preserves the visual layout. Further, in the computer system, the at least one hidden field includes a plurality of hidden fields. And if the at least one hidden field includes a plurality of hidden fields than the plurality of hidden fields may have a number of hidden fields, where the at least one processor is further configured to randomize the number of hidden fields in the updated version of the web page.

In at least one example, a non-transitory computer readable medium is provided. The non-transitory computer readable medium comprises a sequence of instructions to determine bot submissions of web pages. This sequence of instructions includes instructions to retrieve, from a server, a web page, identified by a client request, via a network interface, where the web page comprises a plurality of original fields. The sequence of instructions further includes instructions to embed, in the web page, a plurality of hidden fields, transmit, to the client, the web page with the plurality of hidden fields. The sequence of instructions continue with instructions to receive, from the client, a completed web page, where the completed web page further comprises the plurality of original fields, the plurality of hidden fields, and a plurality of entry data associated with the plurality of original fields. The sequence of instructions also includes instructions to determine if the completed web page further comprises a plurality of entry data associated with the plurality of hidden fields. Where the completed web page does not comprise a plurality of entry data associated with the plurality of hidden fields, the sequence of instructions include instructions to remove, from the completed web page, the plurality of hidden fields, and transmit, to the server, the completed web page.

Examples of the non-transitory computer readable medium can include one or more of the following features.

In the non-transitory computer readable medium, the sequence of instructions can further include instructions to generate a session identifier, generate a plurality of hidden field identifiers of the plurality of hidden fields, and store, in a memory, the session identifier in association with the plurality of hidden field identifiers.

In the non-transitory computer readable medium, the sequence of instructions may include further instructions to transmit, to the client, the session identifier, and receive from the client, the session identifier in association with the completed web page.

The non-transitory computer readable medium may further include a distributed hash table and instructions to store, in the distributed hash table, the session identifier in association with the plurality of identifiers, each associated with a hidden field, and retrieve, from the distributed hash table, using the session identifier, at least one identifier of the at least one hidden field.

In the non-transitory computer readable medium, the plurality of hidden fields may include a randomly generated number of hidden fields.

In the non-transitory computer readable medium, where the completed web page does comprise a plurality of entry data associated with the plurality of hidden fields, the sequence of instructions comprises further instructions to block the completed web page from being transmitted to the server.

In the non-transitory computer readable medium, the web page further comprises a visual layout where the instructions, to embed at least one hidden field, preserve the visual layout.

In at least one example, a method to determine bot submissions of web pages, via a computer system, is provided. The method includes receiving, from a client via a network interface, a request for a web page, transmitting the request to a server, and receiving, from the server, an initial version of the web page. The initial version of the web page includes at least one original field. The method further comprises embedding, in the initial version of the web page, at least one hidden field, and transmitting, to the client via the network interface, the updated version of the web page with the at least one hidden field. The method continues by receiving, from the client via the network interface, a completed version of the web page. Next, the method includes determining that the at least one hidden field in the completed version of the web page is populated, and where the at least one hidden field is not populated, removing the at least one hidden field, creating a final version of the web page. Finally, the method proceeds by transmitting, to the server, the final version of the web page.

Examples of the method to determine bot submissions of web pages can include one or more of the following steps.

The method to determine bot submissions of web pages, may further include generating a session identifier, generating at least one identifier of the at least one hidden field, and storing, in a memory system, the session identifier in association with the at least one identifier of the at least one hidden field.

The method to determine bot submissions of web pages, may further comprise transmitting, to the client, the session identifier, and receiving, from the client, the session identifier in association with the completed version of the web page.

The method to determine bot submissions of web pages, may also include storing, in a distributed hash table, the session identifier in association with the at least one identifier of the at least one hidden field, and retrieving, from the distributed hash table, using the session identifier, the at least one identifier of the at least one hidden field.

Still other aspects, examples and advantages of these aspects and examples, are discussed in detail below. Moreover, it is to be understood that both the foregoing information and the following detailed description are merely illustrative examples of various aspects and features and are intended to provide an overview or framework for understanding the nature and character of the claimed aspects and examples. Any example or feature disclosed herein can be combined with any other example or feature. References to different examples are not necessarily mutually exclusive and are intended to indicate that a particular feature, structure, or characteristic described in connection with the example can be included in at least one example. Thus, terms like “other” and “another” when referring to the examples described herein are not intended to communicate any sort of exclusivity or grouping of features but rather are included to promote readability.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1A is a block diagram illustrating a computer system, in accordance with an example of the present disclosure.

FIG. 1B is a block diagram illustrating a computer system, in accordance with an example of the present disclosure.

FIG. 2 is a flow diagram of a method to determine bot submissions, in accordance with an example of the present disclosure.

FIG. 3 is a flow diagram of a method to determine bot submissions, in accordance with an example of the present disclosure.

FIG. 4 is a process map of a method to determine bot submissions, in accordance with an example of the present disclosure.

FIG. 5 is a process map of a method to determine bot submissions, in accordance with an example of the present disclosure.

FIG. 6 is a block diagram of a network environment of computing devices in which various aspects of the present disclosure can be implemented.

### DETAILED DESCRIPTION

As discussed herein previously, automated software programs, bots, are responsible for over 40% of network traffic. While some bots are useful, many exist solely to spread spam across a network by creating fake user accounts, operating stolen accounts, or overwhelming networks with other fake submissions of web pages. Bots access web pages, analyze them for information fields, fill them with randomly generated data, and submit the completed pages back to the server. These submissions risk corrupting data collection, skewing algorithms, and spreading spam. Some methods exist for parsing web page submissions for undesired bot activity, but none of these methods address identifying these bot submissions in real time.

Disclosed herein is a method and system for identifying and preventing bot submissions of web pages in real time. Web pages that bots interact with can include web forms, Hypertext Markup Language (HTML) web forms, and account registrations and logins.

This system can involve an intermediate processor or can be programmed to occur directly on the web server. The acting devices of the process are the client device, an intermediate device, and a server. In some instances, the client device hosts a client application. The client application can be and application configured for an interactive user experience, such as a browser, an operating system logon control (e.g. a MICROSOFT WINDOWS system logon), a digital workspace application, (e.g., the Citrix Workspace™ application commercially available from Citrix Systems, Inc. of Fort Lauderdale, Fla., in the United States) or the like. In some examples the intermediate device may be a Citrix Application Delivery Controller (ADC).

The intermediate device can host a bot detection service as described herein. The server can host a web server, an application server, an email server, a web proxy server or another server application that transmits content with which the user interacts. The choice of server depends on the content (e.g., web page or form) to be provided.

An example of the bot detection method and system begins with a request from a client application for a web page. The client application can include either a browser or an operating system. The client application can include a digital workspace client.

Upon receipt of the request, the bot detection service may create a unique session identifier and store this identifier in a memory. The unique session identifier includes unique information about the client application session. After receipt of the request, the bot detection service requests the web page from the server application.

Once the bot detection service receives that web page, the bot detection service randomizes and adds at least one hidden field to the web page. These fields may include one or more checkboxes, text, number, email, password fields, radio buttons, and drop-down lists. The bot detection service hides the added fields, thereby preventing the client application from rendering them. For example, these fields may be hidden by accessing and defining the CSS, HTML, or Javascript properties. In some examples, the bot detection service may define the input type as “hidden” or display as “none”.

Alternative methods exist to make a field not visible to a genuine user. This may include decreasing the font size to a nearly unreadable size. Another method, for making a field invisible to a genuine user, may include matching the font color to the background of the web page. Thus, camouflaging the field. Alternatively, the field's background can be made transparent and therefore un-viewable by the genuine user.

In these examples, the bot detection system adds the hidden fields, to the web page, in a manner that preserves the initial page layout. Thus, the client application renders visually indistinguishable web pages whether a bot detector is used or not.

Client applications that a genuine user interacts with will not populate the hidden fields because the application only populates data in response to user input, and a user cannot input data into a field they cannot see. Alternatively, bots will populate the hidden fields because they can detect the fields and bots are not configured to access and assess the CSS, HTML, or Javascript properties.

Once the bot detection service hides the added fields, the bot detection service may create at least one identifier for each hidden field and store the hidden field identifiers in association with the unique session identifier. In some examples, this unique session identifier may be attached to the revised requested web page as a cookie. The updated/revised requested web page is then sent to the client.

If the client application is a bot, then the bot executes at least one data entry associated with a field, including data entries associated with the hidden fields. In some examples, the bot randomizes data entries for each field. Alternatively, if the client application is not a bot, then the client application associates each genuine user data entry with the respective field. Upon completion of the data entry, the client transmits the web page via a POST or other similar command.

The bot detection service receives a completed web page from the client application. A completed web page typically includes, the original fields, the hidden fields, and a data entry in association with at least one of the fields. Once received, the bot detection service retrieves the unique session identifier from the completed web page and uses this unique session identifier to retrieve the hidden field identifiers from the memory. The service uses the hidden field identifiers to identify the hidden fields. Once found, the bot detection service parses the hidden fields and determines if there is a data entry associated with at least one hidden field. If a data entry is associated with a hidden field, i.e. a bot submitted the web page, then the bot detector service blocks the web page, and does not transmit the web page to the server. If no data is associated with the hidden fields, i.e. a genuine user interacted with the application that submitted the web page, then the bot detection service removes the added hidden fields and transmits the web page to the server application.

In some examples, the bot detection system may send a notification to the bot that their submission was blocked. In other examples, the bot detection system may send a notification to the bot that their form was successfully submitted, even though it was not.

Examples of the methods and systems discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Automated Web Submission Detection System

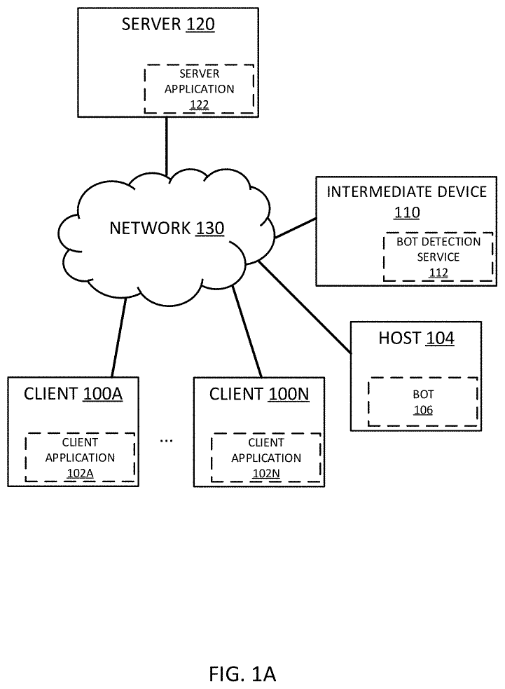

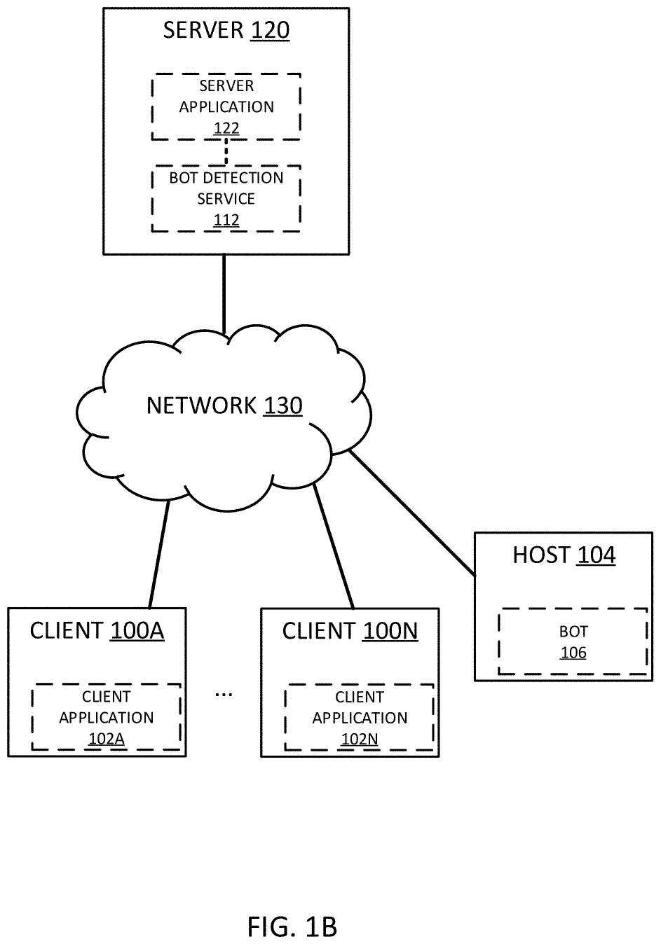

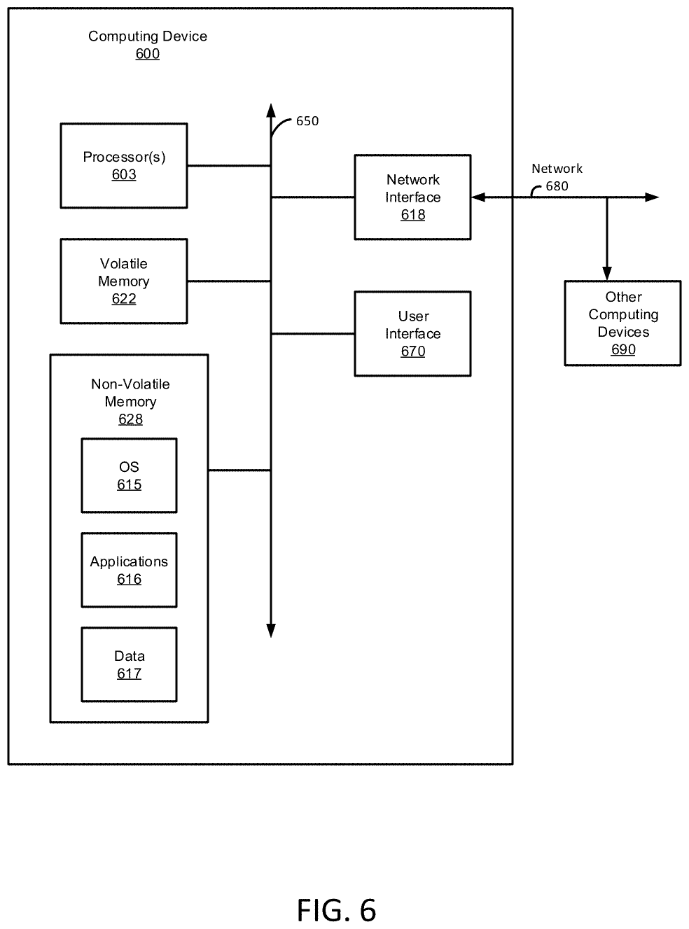

FIG. 1A illustrates a computer system, in accordance with an example of the present disclosure. As shown in FIG. 1A, the computer system includes a server computer 120, an intermediate device 110, a plurality of client devices 100A-100N, a host computer 104, and a network 130. Each of the server 120, the intermediate device 110, the clients 100A-100N, and the host 104 are in two-way communication with one another, and exchange data via, the network 130. The network 130 can include one or more communication networks through which computing devices can exchange information. Examples of the computing devices that can be used to implement the server 120, the intermediate device 110, each of the plurality of client devices 100A-100N, the host computer 104, and the network 130 are described further below with reference to FIG. 6. It should be noted that, in a least some examples, the intermediate device 110 can include a Citrix ADC.

In some examples, the server 120 is configured to implement a server application 122. In these examples, the server application 122 is configured to interoperate with other processes executing within the illustrated computer system to provide one or more services. For instance, the server application 122 can be a web server configured to serve web pages to browsers that request the same via the network 130. These web pages may include HTML files, HTML forms, web forms, XHTML files, image files, style sheets, scripts, or other types of files.

In certain examples, the clients 100 implement a plurality of client applications 102A-102N. In these examples, one or more of the client applications 102A-102N is configured to interact with genuine users via a user interface. Further, in these examples, one or more of the client applications 102A-102N is configured to interoperate with the server application 122, via a system interface, to access the service provided by the server application 122. This system interface may include a network interface and a software stack configured to drive the network interface. The system interface may further include additional layers of software (e.g., a communication protocol, such as hypertext transfer protocol (HTTP), and/or a more specialized application programming interface (API)) that a client application 102 can use to transmit request messages to and receive request messages from the server application 122. For instance, in some examples, one or more of the client applications 102A-102N may include a commercially available browser. Additionally or alternatively, in some examples, one or more of the client applications 102A-102N may include a digital workspace client with an embedded browser, such the Citrix Workspace™ application. In these and other examples, the client applications 102A-102N may be configured to receive input from users, transmit requests for web pages to the server application 122, and receive responses from the server application 122 that include the web pages. Further the client applications 102A-102N may be configured to render the web pages to users, receive input directed to interactive content included in the web pages, and transmit data generated from the input to the server application 122 for subsequent processing. In this way, the client applications 102A-102N may enable users to request web pages, which may include web forms, from the server application 122. Further the client applications may enable users to interact with content within the web pages and to return web pages (including completed web forms) to the server application 122.

In some examples, the host 104 implements a bot 106. In these examples, the bot 106 is configured to interoperate with the server application 122 in a manner that simulates a genuine user. For instance, the bot 106 may be configured to utilize a system interface configured like those of one or more of the client applications 102A-102N. Further, the bot 106 may be configured to interoperate with the server application 122 so utilize the service provided thereby. As such, the bot 106, in some examples, may request a web page, interoperate with the web page to enter data and/or make selections, and return the populated web page to the server application 122.

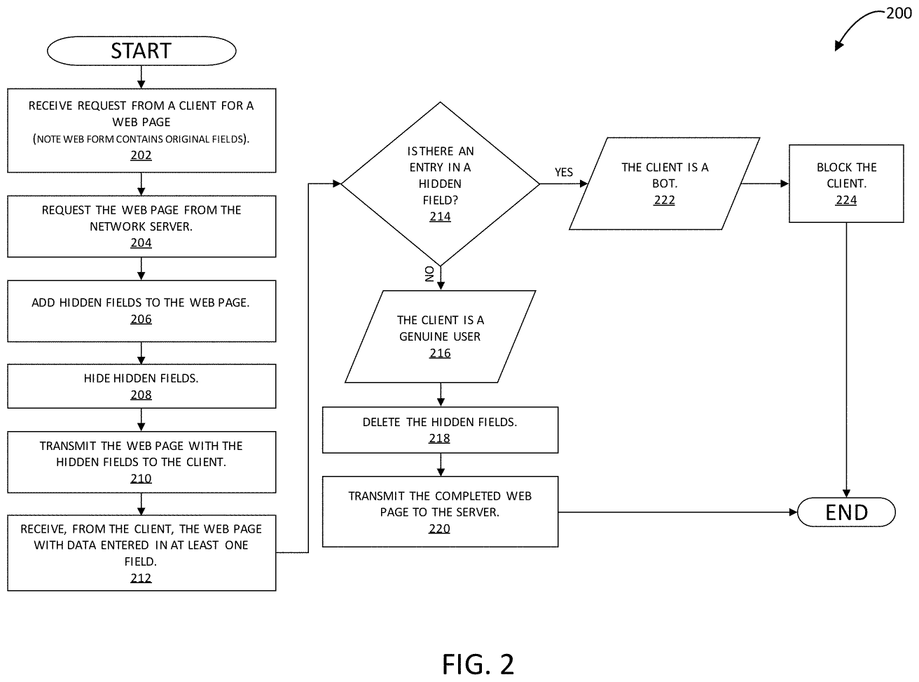

In some examples, the intermediate device 110 implements a bot detection service 112. In these examples, the bot detection service 112 is configured to interoperate with one or more of the client applications 102A-102N via the network 130. Further, in these examples, the bot detection service 112 is configured to discern between the client applications 102A-102N and the bot 106 and prevent the bot 106 from successfully utilizing the service provided by the server application 122. In these examples, requests and/or responses addressed to the server application 122 are redirected to the bot detection server 112 for processing. The bot detection service 112 is configured to interoperate with the server application 122 to process the requests and/or responses and to determine whether the requests and/or responses originate from the bot 106. The bot detection service 112 is also configured to intervene where the bot detection service 112 determines that the request and/or responses originate from the bot 106. These interventions may include not providing at least one response to the server application 122. Examples of processes that the bot detection service 112 is configured to execute to protect the server application 122 from the bot 106 are described further below with reference to FIGS. 2-5.

In some examples, the bot detection service 112 is configured to allocate and maintain a hash table, or more particularly a distributed hash table (DHT). This DHT may be used to store key-value pairs. The DHT may provide a lookup service for the key-value pairs. In some examples, the bot detection service 112 is configured to store a key-value pair in a DHT, where the data associated with the added fields is the value and unique data identifying the client's network session is stored as the key. This DHT assists the bot detection service 112 in evaluating the submission from the client application 102 as will be described further below.

FIG. 1B is an alternative example of a computer system, in accordance with an example of the present disclosure. As shown in FIG. 1B, the computer system omits the intermediate device 110. Further, as shown in FIG. 1B, the server 120 hosts both the server application 122 and the bot detection service 112. As with the example illustrated in FIG. 1B, the bot detection service 112 is configured to discern between the client applications 102A-102N and the bot 106 and prevent the bot 106 from successfully utilizing the service provided by the server application 122.

Automated Web Submission Detection Processes

FIG. 2 illustrates an example process 200 to identify bot submissions (e.g., requests and/or responses). The example process 200 may be executed, for example, by a bot detection service, such as the bot detection service 112 illustrated in FIGS. 1A and 1B.

At 202, the bot detection service receives a request from a client (e.g., one of the client applications 102A-102N or the bot 106 of FIGS. 1A and 1B) for a web page. At 204, the bot detection service requests the web page from the server application (e.g., the server application 122 of FIGS. 1A and 1B), via a network (e.g., the network 130 of FIGS. 1A and 1B). The requests and receipts may be executed via a HTTP GET request from the client and a HTTP GET request from the bot detection service.

As the method 200 proceeds, at 206, the bot detection service adds hidden fields to the web page. These fields may include one or more checkboxes, text, number, email, password fields, radio buttons, and drop-down lists. These added fields are hidden in a way that prevents the client from displaying the hidden fields when it renders the web page for a genuine user. For example, these fields may be hidden by accessing and defining CSS, HTML, or Javascript properties such as defining the input type as “hidden” or the display as “none”. Commonly, bots are designed to ignore programming properties and therefore bots do not easily distinguish between original fields and the added hidden fields. In some examples, the number of hidden fields added to the web page is randomized by the bot detection service.

At 210, the bot detection service transmits an updated version of the web page to the client, via the network. The updated version of the web page includes the original web page fields with the added hidden fields. This transmission may be executed via an HTTP POST request from the bot detection service to the client.

Then at 212, the client, via a system interface, POSTs a completed version of the web page to the bot detection service. The completed version of the web page may comprise, original fields, added hidden fields, and a series of data entries associated with the web page fields.

At 214 of FIG. 2, the process 200 reaches a decision point 214, where the bot detection service parses the completed web page for data entries associated with the added hidden fields. If the values at the hidden fields are null, the process 200 continues, at 216, and determines that the client transmitted a web page where the data entries associated with the original fields were directed by a genuine user input. At 218, the bot detection service deletes the added hidden fields, thus creating a final version of the web page. The final version of the web page may include the original fields, as well as the data entries associated with the original fields. At 220, the bot detection service, transmits the final web page to the server application. In some examples, the bot detection service may transmit the final web page using a POST command.

Alternatively, if at decision point 214, the values at the hidden fields are not null, then the process 200 continues to 222, where the bot detection service determines that the client is a bot. At 224, the bot detection service blocks transmissions from that unique session identifier and does not transmit the completed web page to the server application.

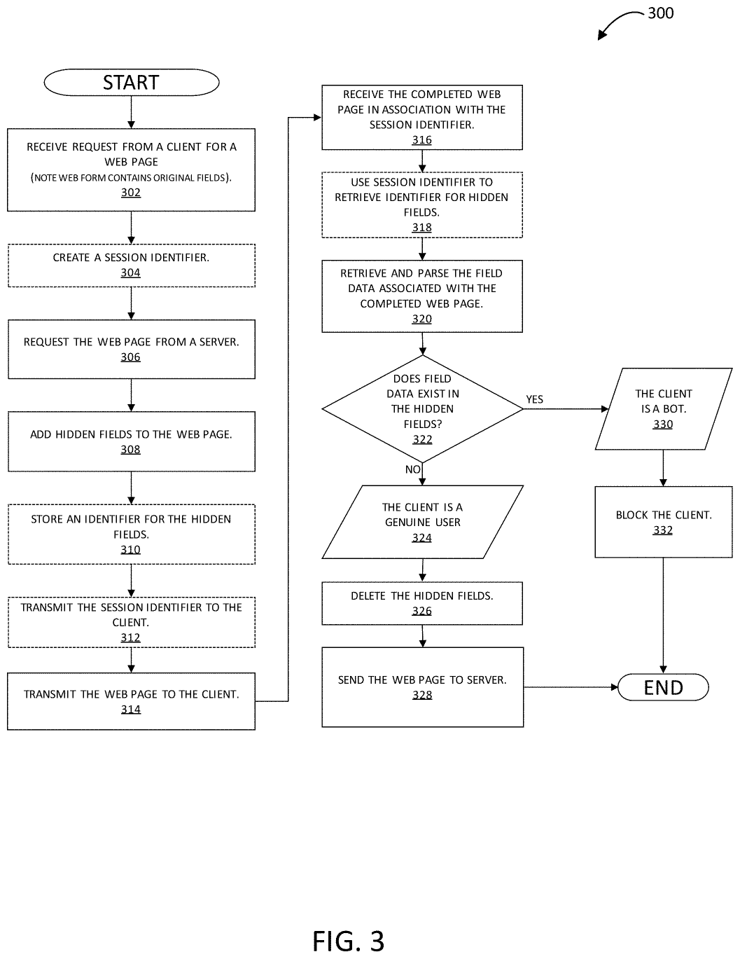

FIG. 3 illustrates an alternative method 300 to identify bot submissions (e.g., requests and/or responses). The example method 200 may be executed, for example, by a bot detection service, such as the bot detection service 112 illustrated in FIGS. 1A and 1B. Many steps are similar to the process as depicted and described in relation to FIG. 2 and therefore the variations discussed above with reference to FIG. 2 apply to FIG. 3 as well.

At 302, the bot detection service receives a request from a client (e.g., one of the client applications 102A-102N or bot 106 of FIGS. 1A and 1B) for a web page. At 304, the bot detection service creates a session identifier. A session identifier may include any information that allows the bot detector to identify the session. In some examples, the session identifier may include a unique number that is assigned by the bot detection service and stored as a cookie, form field, or uniform resource locator (URL). In these examples, the session identifier may be an incrementing static number, or the bot detection service may execute a process that integrates additional identifying information such as the date and time of the web page request.

Subsequent to 304, at 306, the bot detection service requests the web page from the server application (e.g., the server application 122 of FIGS. 1A and 1B), via a network (e.g., the network 130 of FIGS. 1A and 1B). The requests and receipts may be executed via a HTTP GET request from the client and a HTTP GET request from the bot detection service.

At 308, similar to FIG. 2, the bot detection service adds hidden fields to the web page. Then at 310, the bot detection service stores one or more identifier for the hidden fields. In some examples, each field in the web page may be numbered sequentially and therefore the identifier for each hidden field is the sequential number associated with the field. In some examples that include a DHT, the identifiers associated with the hidden fields are stored as the value, while the session identifier is stored as the key.

At 312 and 314, the bot detection service transmits the session identifier as well as the updated web page to the client. The updated web page may include the original fields, in addition to the added hidden fields. Similar to transmissions previously discussed with reference to FIG. 2, this updated web page may be transmitted via a POST command.

At 316, the bot detection service receives the completed web page in association with the session identifier from the client. The completed version of the web page may comprise, original fields, added hidden fields, and a series of data entries associated with the web page fields. At 318, the bot detection service retrieves the session identifier and uses it to retrieve the hidden field identifiers.

The bot detection service, subsequently at 320, retrieves and parses the field data associated with the completed web page. At 322, the bot detection system, determines whether field data exists in association with the hidden fields. If field data does exist in association with the hidden field then the process proceeds to 330, where the bot detection service identifies the client as a bot and, at 332, the network session is blocked.

Alternatively, if there no field data exists in association with the hidden fields, then at 324, the bot detection service determines that the client transmitted genuine user inputs associated with the original fields. Subsequently at 326, the bot detection service 112 deletes the hidden fields, and at 328, the bot detection service transmits the final web page to the server application 122. The final web page comprising the client data entries and the original web page fields.

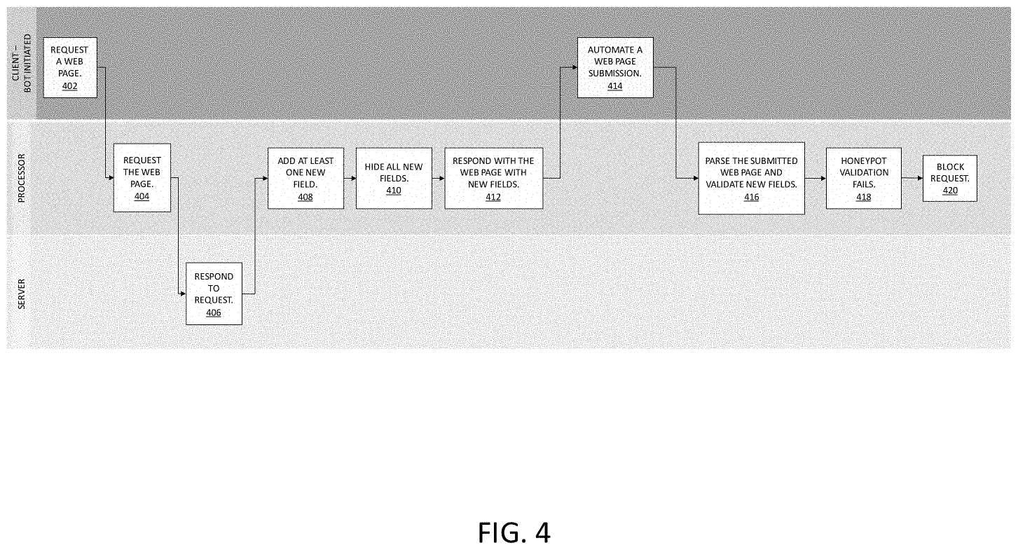

FIG. 4 illustrates which devices, from a bot detection system, such as the bot detection system illustrated in FIGS. 1A and 1B, are responsible for each process step. There are three devices represented by the three horizontal rows in FIG. 4; a client (e.g., one of the client applications 102A-102N or the bot 106 of FIGS. 1A and 1B), a bot detection service, (e.g., instructions executed by a processor, hence the label processor), and a server (e.g., the server application 122 of FIGS. 1A and 1B). In FIG. 4, the client is a bot.

At 402, the bot requests a web page via a request from the client. At 404, the processor requests the web page from the server. At 406, the server responds to the request and transmits the requested web page. At 408, the processor adds at least one new field. At 410, the processor hides all the new hidden fields, and at 412, the processor responds to the client's request with the updated web page. At 414, the client, which is a bot, automates a web page submission. In some examples, the bot randomizes data entries for all fields, ignoring the programming properties, and therefore also providing data entries associated with the hidden fields. At 416, the processor parses the submitted web pages and validates the hidden fields. In some examples, this validation process is referred to as a honeypot validation, the honeypot validation fails if the processor finds at least one data entry associated with the hidden fields. Alternatively, the honeypot validation succeeds if the processor does not find at least one data entry associated with the hidden field. In FIG. 4, at 418, the processor determines that the honeypot validation fails. At 420, the processor blocks the bot's web page request.

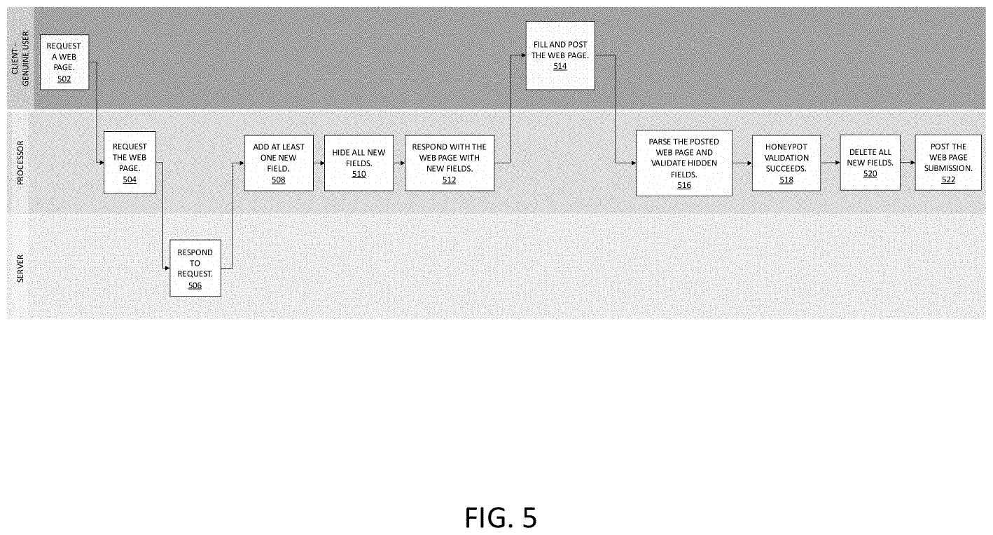

FIG. 5, like FIG. 4, illustrates which devices, from a bot detection system, of FIG. 1A, are responsible for each process step. There are three devices represented by the three horizontal rows in FIG. 5; a client (e.g., one of the client applications 102A-102N or the bot 106 of FIGS. 1A and 1B), a bot detection service, (e.g., instructions executed by a processor, hence the label processor), and a server (e.g., the server application 122 of FIGS. 1A and 1B). In FIG. 5, the client is a client application that is interactive with a genuine user, for simplicity FIG. 5 labels the client as a genuine user.

At 503, the client requests a web page. At 504, the processor forwards that request to the server. At 506, the server responds to the processor's request and transmits the web page. At 508, the processor adds at least one new field to the initial web page, creating an updated web page. At 510, the processor hides the at least one new field using methods previously described in reference to FIG. 2. At 512, the processor transmits the updated web page to the client. At 514, the client associates user inputs with particular fields, once complete, the client transmits the completed web page to the processor. At 516, the processor parses the web page and validates the hidden fields. At 518, the processor determines that the honeypot validation test succeeds. Thus, in this example, the processor did not identify any data associated with the hidden fields. At 520, the processor deletes the new hidden fields, and at 522, the processor transmits the final web page to the server.

Computing Device for Bot Detection Systems

FIG. 6 is a block diagram of a computing device 600 configured to implement various bot detection systems and processes in accordance with examples disclosed herein.

The computing device 600 includes one or more processor(s) 603, volatile memory 622 (e.g., random access memory (RAM)), non-volatile memory 628, a user interface (UI) 670, one or more network or communication interfaces 618, and a communications bus 650. The computing device 600 may also be referred to as a client device, computing device, endpoint, computer, or a computer system.

The non-volatile (non-transitory) memory 628 can include: one or more hard disk drives (HDDs) or other magnetic or optical storage media; one or more solid state drives (SSDs), such as a flash drive or other solid-state storage media; one or more hybrid magnetic and solid-state drives; or one or more virtual storage volumes, such as a cloud storage, or a combination of such physical storage volumes and virtual storage volumes or arrays thereof.

The user interface 670 can include a graphical user interface (GUI) (e.g., controls presented on a touchscreen, a display, etc.) and one or more input/output (I/O) devices (e.g., a mouse, a keyboard, a microphone, one or more speakers, one or more cameras, one or more biometric scanners, one or more environmental sensors, and one or more accelerometers, one or more visors, etc.).

The non-volatile memory 628 stores an OS 615, one or more applications or programs 616, and data 617. The OS 615 and the application 616 include sequences of instructions that are encoded for execution by processor(s) 603. Execution of these instructions results in manipulated data. Prior to their execution, the instructions can be copied to the volatile memory 622. In some examples, the volatile memory 622 can include one or more types of RAM or a cache memory that can offer a faster response time than a main memory. Data can be entered through the user interface 670 or received from the other I/O device(s), such as the network interface 618. The various elements of the device 600 described above can communicate with one another via the communications bus 650.

The illustrated computing device 600 is shown merely as an example client device or server and can be implemented within any computing or processing environment with any type of physical or virtual machine or set of physical and virtual machines that can have suitable hardware or software capable of operating as described herein.

The processor(s) 603 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values or using analog signals.

In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory.

The processor(s) 603 can be analog, digital or mixed. In some examples, the processor(s) 1003 can be one or more local physical processors or one or more remote-located physical processors. A processor including multiple processor cores or multiple processors can provide functionality for parallel, simultaneous execution of instructions or for parallel, simultaneous execution of one instruction on more than one piece of data.

The network interfaces 618 can include one or more interfaces to enable the computing device 1000 to access a computer network 680 such as a Local Area Network (LAN), a Wide Area Network (WAN), a Personal Area Network (PAN), or the Internet through a variety of wired or wireless connections, including cellular connections and Bluetooth connections. In some examples, the network 680 may allow for communication with other computing devices 690, to enable distributed computing.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure and are intended to be within the scope of the examples discussed herein. Accordingly, the foregoing description and drawings are by way of example only.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

1. A system to identify bot submissions of web pages in real time, the system comprising:
a network interface;
a memory; and
at least one processor coupled to the memory and the network interface, the at least one processor configured to:
receive, from a client via the network interface, a request to obtain a web page;
transmit the request to a server;
receive an initial version of the web page from the server;
embed at least one hidden field in the initial version of the web page to create an updated version of the web page;
transmit, to the client, a response to the request comprising the updated version of the web page;
receive, from the client, a completed version of the web page;
determine whether the at least one hidden field is populated within the completed version of the web page;
where the at least one hidden field is not populated
remove the at least one hidden field from the completed version of the web page to create a final version of the web page, and
send the final version of the web page to the server.

2. The system of claim 1, further comprising a memory coupled to the at least one processor, the at least one processor being further configured to:
generate a session identifier;
generate at least one identifier of the at least one hidden field; and
store, in the memory, the session identifier in association with the at least one identifier of the at least one hidden field.

3. The system of claim 2, the at least one processor being further configured to:
transmit, to the client, the session identifier;
receive, from the client, the session identifier in association with the completed version of the web page.

4. The system of claim 3, further comprising a distributed hash table, the at least one processor being further configured to:
store, in the distributed hash table, the session identifier in association with the at least one identifier of the at least one hidden field; and
retrieve, from the distributed hash table, using the session identifier, the at least one identifier of the at least one hidden field.

5. The system of claim 1, where the at least one hidden field within the completed version of the web page is populated, the processor is further configured to block the client.

6. The system of claim 1, the initial version of the web page comprises a visual layout, wherein to embed the at least one hidden field preserves the visual layout.

7. The system of claim 1, the at least one hidden field further comprising a plurality of hidden fields.

8. The system of claim 7, the plurality of hidden fields having a number of hidden fields, wherein the at least one processor being further configured to randomize the number of hidden fields in the updated version of the web page.

9. A non-transitory computer readable medium to store executable sequences of instructions to determine bot submissions of web pages, the sequences of instructions comprising instructions to:
retrieve, from a server, a web page, identified by a client request, via a network interface;
the web page comprises a plurality of original fields:
embed, in the web page, a plurality of hidden fields;
transmit, to the client, the web page with the plurality of hidden fields;
receive, from the client, a completed web page,
the completed web page further comprising,
the plurality of original fields,
the plurality of hidden fields, and
a plurality of entry data associated with the plurality of original fields;
determine if the completed web page further comprises a plurality of entry data associated with the plurality of hidden fields;
where the completed web page does not comprise a plurality of entry data associated with the plurality of hidden fields, remove, from the completed web page, the plurality of hidden fields; and
transmit, to the server, the completed web page.

10. The computer readable medium of claim 9, the sequences of instructions further include instructions to:
generate a session identifier;
generate a plurality of hidden field identifiers of the plurality of hidden fields; and
store, in a memory, the session identifier in association with the plurality of hidden field identifiers.

11. The computer readable medium of claim 10, the plurality of hidden field identifiers further comprising a plurality of identifiers each associated with a hidden field, where each identifier is associated with a hidden field and is configured to point to the tab index and name of the hidden field that the identifier is associated with.

12. The computer readable medium of claim 10, further comprising instructions to:
transmit, to the client, the session identifier;
receive, from the client, the session identifier in association with the completed web page.

13. The computer readable medium of claim 12, further comprising a distributed hash table and instructions to:
store, in the distributed hash table, the session identifier in association with the plurality of identifiers each associated with a hidden field; and
retrieve, from the distributed hash table, using the session identifier, the at least one identifier of the at least one hidden field.

14. The computer readable medium of claim 9, the plurality of hidden fields further comprising a randomly generated number of hidden fields.

15. The computer readable medium of claim 9, where the completed web page does comprise a plurality of entry data associated with the plurality of hidden fields, the sequence of instructions comprises further instructions to block the completed web page from being transmitted to the server.

16. The computer readable medium of claim 9, the web page comprises a visual layout, wherein the instructions to embed at least one hidden field preserves the visual layout.

17. A method to determine, via a computer system in real time, bot submissions of web pages, the method comprising:
receiving, from a client via a network interface, a request for a web page;
transmitting, to a server, the request;
receiving, from the server, an initial version of the web page,
the initial version of the web page further comprising at least one original field;
embedding, in the initial version of the web page, at least one hidden field creating an updated version of the web page;
transmitting, to the client via the network interface, the updated version of the web page with the at least one hidden field;
receiving, from the client via the network interface, a completed version of the web page;
determining that the at least one hidden field in the completed version of the web page is populated;
where the at least one hidden field is not populated, removing the at least one hidden field, creating a final version of the web page; and
transmitting, to the server, the final version of the web page.

18. The method of claim 17, further comprising:
generating a session identifier;
generating at least one identifier of the at least one hidden field; and
storing, in a memory, the session identifier in association with the at least one identifier of the at least one hidden field.

19. The method of claim 18, further comprising:
transmitting, to the client, the session identifier;
receiving, from the client, the session identifier in association with the completed version of the web page.

20. The method of claim 19, further comprising:
storing, in a distributed hash table, the session identifier in association with the at least one identifier of the at least one hidden field; and
retrieving, from the distributed hash table, using the session identifier, the at least one identifier of the at least one hidden field.
